(19) United States
(12) Patent Application Publication
(10) Pub. No.: US 2016/0094262 A1
(43) Pub. Date: Mar. 31, 2016

(54) Retractable Holder System for Mobile Handheld Devices

(71) Applicant: Jaroslav Chorny, North Vancouver BC (CA)

(72) Inventor: Jaroslav Chorny, North Vancouver BC (CA)

(21) Appl. No.: 14/498,999

(22) Filed: Sep. 26, 2014

(51) Int. Cl. H04B 1/3888; H04B 1/3827

(52) U.S. Cl. CPC H04B 1/3888; H04B 1/385

(57) ABSTRACT

A holder system for a device has a retracting mechanism allowing efficient storage of a lanyard inside the housing. The holder system has a housing and a slider which have one or more pivotal drums. The lanyard travels around the one or more pivotal drums alternating between the housing and slider, and creating folds. When a wrist strap is present, drawing the wrist strap out from the housing pulls the moving slider downwards, extending the length of the folds and storing more lanyard inside the housing. Conversely, drawing the lanyard out of the housing draws the wrist strap inside.

### TECHNICAL FIELD

This invention relates to holder systems for mobile handheld devices, and particularly, to systems and methods of retracting such holders when not in use.

### CROSS REFERENCE TO RELATED APPLICATIONS

None.

### GOVERNMENT SUPPORT

None.

### BACKGROUND

The present invention relates to holder systems for mobile handheld devices such as smartphones, tablets, cameras, personal music players, flashlights, identification cards, etc., and the like. More particularly, the present invention relates to holder systems having a lanyard, and a manner of retracting such lanyard into the holder when the lanyard is not in use.

Holder systems with retractable mechanisms are known. Known retractable mechanisms may incorporate a housing that contains some type of rotatable reel on which a retractable line is wound by a spiral spring.

U.S. Pat. No. 8,408,513 discloses a holder system for mobile devices having a pair of spaced cord ports in a holder base, with each cord port receiving a line part of a retractable cord that is engaged to a retractor mechanism. The retractor mechanism is composed of a housing that constrains some type of rotatable reel on which the retractable line is wound, one end of the retractable line being attached thereto. Typically the reel is connected to some type of spiral spring.

U.S. Pat. No. 8,224,404 discloses an accessory strap securing mechanism positioned on a portable electronic device. A holding portion includes a hook and a projection. A securing member is rotatable to allow the accessory strap to be coiled around the holding portion and an end of the accessory strap attached to the projection.

U.S. Pat. No. 7,354,304 discloses a retractable cord assembly adapted to secure to a portable electronic device to a clippable housing. A cord has two ends, the first of which is connected to and wound about a spring-loaded spool assembly rotatably mounted in the housing. In a wound position, nearly the entire length of cord is wound about the spool assembly, retracting the second end of the cord to a position proximate but outside of the housing.

Rotatable reels on which a retractable line is wound by a spiral spring require many moving parts. The quality of moving parts deteriorate with wear and friction and causes durability and longevity concerns with known systems. Systems incorporating retractable lines wound by spiral spring are therefore inconveniently bulky, unnecessarily complicated, and unreliable.

### SUMMARY

An apparatus for holding a device has a housing with a device receiving location. A movable member has a pivot member and is moveable proximate an inside surface of the housing. A lanyard passes through an opening in the housing such that an outside portion of the lanyard is outside the housing and an inside portion of the lanyard is inside the housing. The inside portion of the lanyard is threaded around the pivot member such that movement of the moveable member in a retracting direction increases the inside portion of the lanyard while decreasing the outside portion of the lanyard. Movement of the moveable member in an extending direction decreases the inside portion of the lanyard while increasing the outside portion of the lanyard.

Another apparatus for holding a device is provided having a housing with a device receiving location. The housing has a plurality of pivot drums on it. A moveable member has a plurality of pivot members on it. The moveable member is moveable proximate an inside surface of the housing.

A lanyard passes through first and second openings in the housing such that an outside portion of the lanyard forms a loop. An inside portion of the lanyard is threaded around the pivot members and pivot drums.

A wrist strap is coupled to the slider. The wrist strap passes through an aperture in the housing. Pulling downward on the wrist strap retracts the lanyard and extends the wrist strap out of the housing. Conversely, pulling on the lanyard retracts the wrist strap and extends the lanyard.

A method of retracting and extending a lanyard within a holder for a device is provided. Pulling upward on the lanyard extends the lanyard outside the holder. Moving a means for moving a moveable member downward retracts the lanyard into the holder.

In a method of retracting and extending a lanyard within a holder for a device, pulling upward on the lanyard extends the lanyard and retracts a wrist strap. Pulling on a wrist strap extends the wrist strap and retracts the lanyard.

### BRIEF DESCRIPTION OF THE DRAWINGS

In Figures which illustrate non-limiting embodiments of the invention:

FIG. 1 is a front perspective view of an embodiment of the invention;

FIG. 2 is a rear perspective view of the embodiment of FIG. 1;

FIG. 3 is a front view of an embodiment of the invention shown around a user's neck;

FIG. 4 is a rear perspective view of an embodiment of the invention shown around a user's wrist;

FIG. 5 is an exploded view of an embodiment of the invention;

FIG. 6 is a rear perspective view of a slider in accordance with an embodiment of the invention;

FIG. 7 is a side elevation cross-sectional view of an embodiment of the invention;

FIG. 8 is a front perspective view of an embodiment of the invention;

FIG. 9 is a front elevation view of the embodiment of FIG. 8;

FIG. 10 is a front perspective view of the embodiment of FIG. 8 with the lanyard in an extended position;

FIG. 11 is a front elevation view of the embodiment of FIG. 8 with the lanyard in an extended position;

FIG. 12 is a front elevation view of an embodiment of the invention having a single pivotal drum;

FIG. 13 is a front elevation view of an embodiment of the invention having two pivotal drums;

FIG. 14 is a front elevation view of an embodiment of the invention having five pivotal drums;

FIG. 15 is a front elevation view of an embodiment of the invention having seven pivotal drums;

FIG. 16 is a front elevation view of an embodiment of the invention having eight pivotal drums;

FIG. 17 is a front elevation view of an embodiment of the invention having nine pivotal drums;

FIG. 18 is a perspective view of an embodiment of the invention;

FIG. 19 is a top elevation view of an embodiment of the invention;

FIG. 20 is a top elevation view of an embodiment of the invention; and

FIG. 21 is a rear perspective view of an embodiment of the invention.

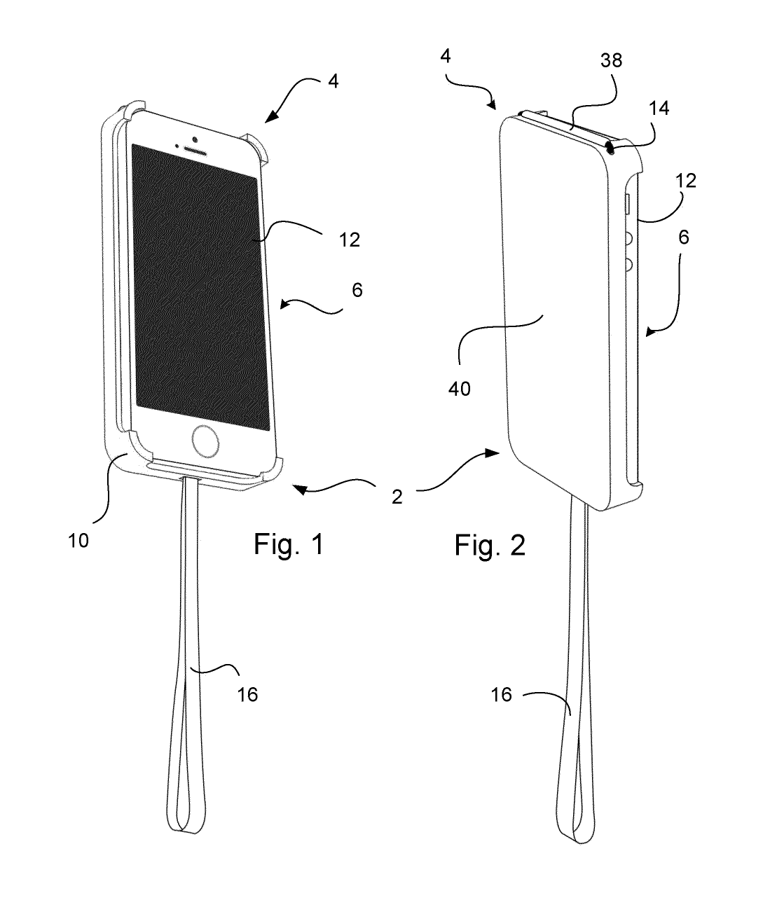

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

With reference to the figures, a holder system 2 is designed to be used in a combination 4 with a mobile handheld device 6 that is held within the holder system 2. The holder system 2 comprises a housing 10, a lanyard 14 and a rear face 40. The lanyard 14 may have a neck strap comfort section 38 for added cushioning when used on a user's neck. A wrist strap 16 may be provided such that when a user pulls the wrist strap downward, thereby extending the wrist strap 16 out of the housing 10, the lanyard 14 will be retracted inside the housing 10. Conversely, pulling on the lanyard 14 will result in extending the lanyard 14 outside the housing 10 while at the same time retracting the wrist strap 16 into the housing 10.

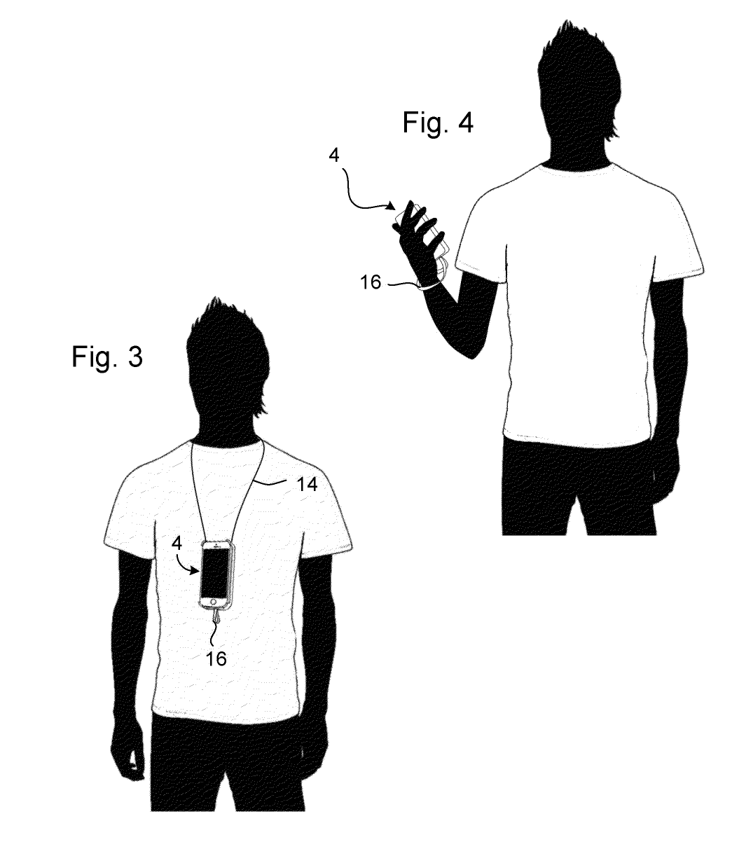

FIG. 3 illustrates a user wearing the holder system 2 in combination 4 with a mobile device 6 with the lanyard 14 extended and placed around the user's neck. FIG. 4 illustrates holder combination 4 having the lanyard 14 retracted and the wrist strap 16 extended and wrapped around the user's wrist.

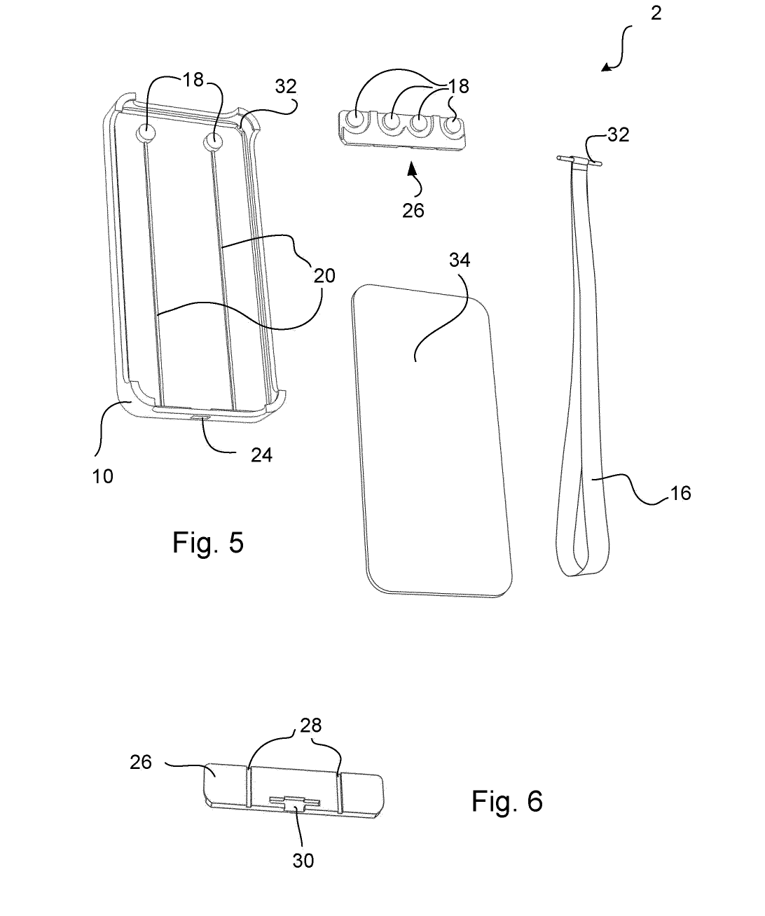

FIG. 5 shows an exploded view of holder system 2 with the lanyard 14 omitted. In this embodiment, housing 10 has two pivotal drums 18 affixed thereto or formed into a continuous piece of material with housing 10. Slider 26 is a movable member which can move in the direction towards and away from the pivotal drums 18 on the housing 10. In this embodiment, the front side of slider 26 has four pivotal drums 18 affixed, formed or moulded thereto. On the rear side of slider 26, threads 28 are designed to cooperate with slider tracks 20 on housing 10 to assist in keeping slider 26 oriented correctly within housing 10 to move in the two intended directions.

Slider 26 has a T-shaped socket 30 for receiving a pin 32 attached to an end of the wrist strap 16.

Housing cover 34 may cover the inner workings of the holder system 2, namely the slider 26, the lanyard 14, and the wrist strap 16, if present. For mobile devices 6 with a flat rear side, holder system 2 may be able to operate without housing cover 34, to reduce size and weight of the holder system 2. Whether or not the housing cover 34 is present, the pivotal drums 18 should protrude high enough such that the back of the mobile device 6 and/or the housing cover 34 does not pinch or squish the lanyard 14. For tight fitting mobile devices 6 within the holder system 2, the ease of movement of slider 26 may be improved when housing cover 34 is present.

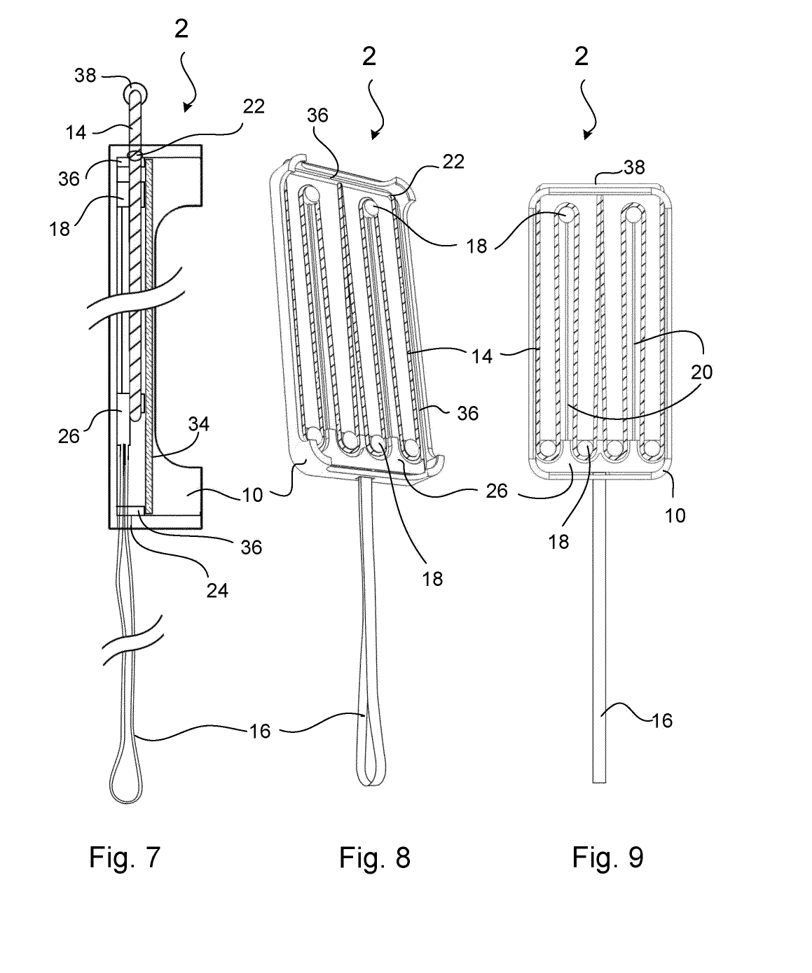

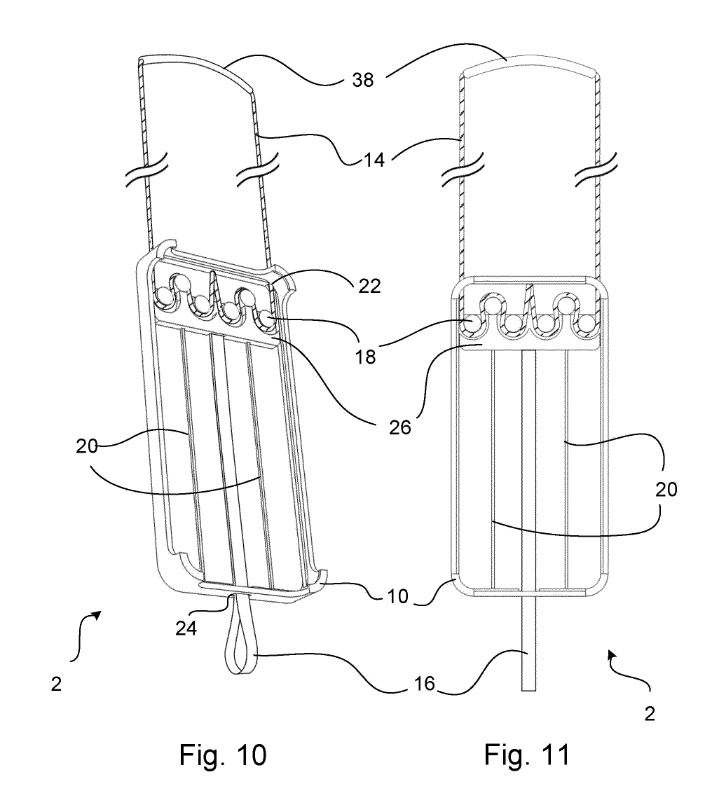

As labeled in FIGS. 7 and 8, housing 10 can be formed with ridges 36 upon which the device 6 can sit. The presence of ridges 36 means that the device 6 and/or the housing cover 34 can firmly fit into the housing 10 and yet does not need to sit firmly against pivotal drums 18 on slider 26. The height of pivotal drums 18 on housing 10 may be slightly longer than the height of pivotal drums 18 on slider 26 to ensure that the slider 26 is not constricted in its movement by any pressure from device 6 or housing cover 34.

Lanyard 14 may enter the inside of the holder system 2 via apertures 22 in housing 10 that may be circular, rectangular or other suitable shape. Alternately as shown in embodiment 64 the housing 10 may be fitted with slots 23 or any other suitable shaped opening to its design to permit access into holder system 2 for lanyard 14.

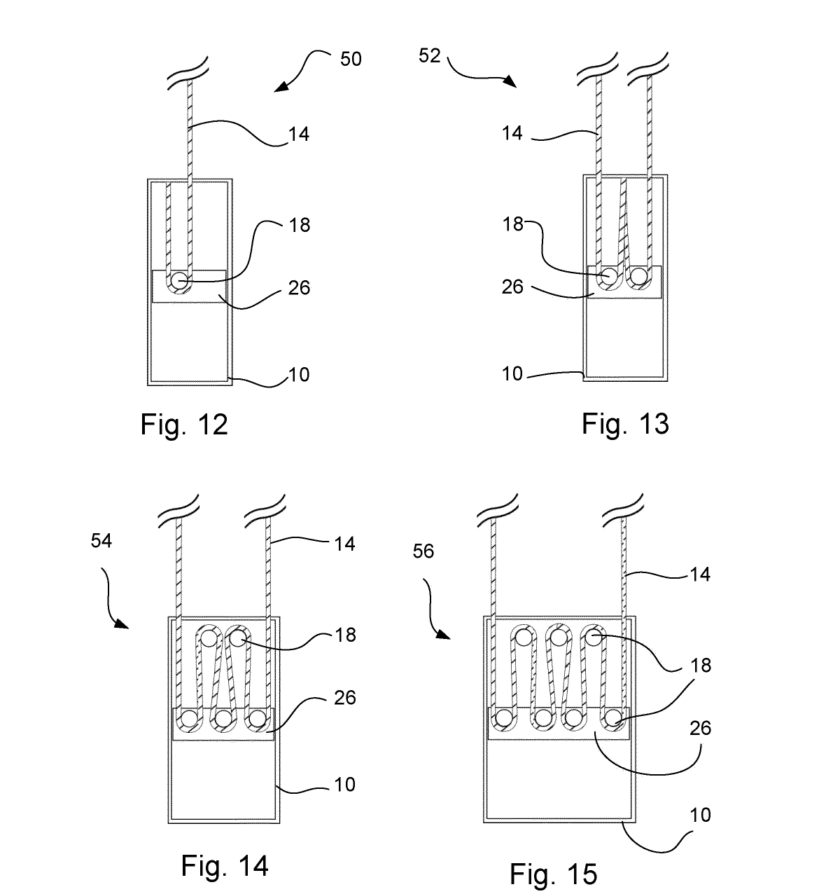

As shown in FIGS. 12-18, the invention may be practiced many different ways.

In FIG. 12, embodiment 50 features a single pivotal drum 18 on slider 26. No corresponding pivotal drum 18 appears on housing 10. Embodiment 50 shows lanyard 14 exiting housing 10 at a single location as would be suitable for use with various ways of holding, pinning or otherwise making use of a single string or tether attachment. One end of lanyard 14 is fixed to a position inside housing 10. The other end of lanyard 14 can be fixed (not shown) to a position on the outside of housing 10, or to itself, for use as a strap.

In FIG. 13, embodiment 52 features two pivotal drums 18 on slider 26 and has two apertures 22 or slots 23 for the lanyard 14 to exit the housing 10. Embodiments with larger numbers of pivotal drums 18 have an increased capacity to shorten the lanyard 14 for the same amount of movement of slider 26.

Embodiments 54, 56 and 58 feature five, seven and eight pivotal drums 18 respectively. For odd numbers of pivotal drums 18 as arranged in embodiments 54 and 56, there is no need to fasten the lanyard 14 to the inside of housing 10. In embodiment 58, the lanyard is attached to slider 26.

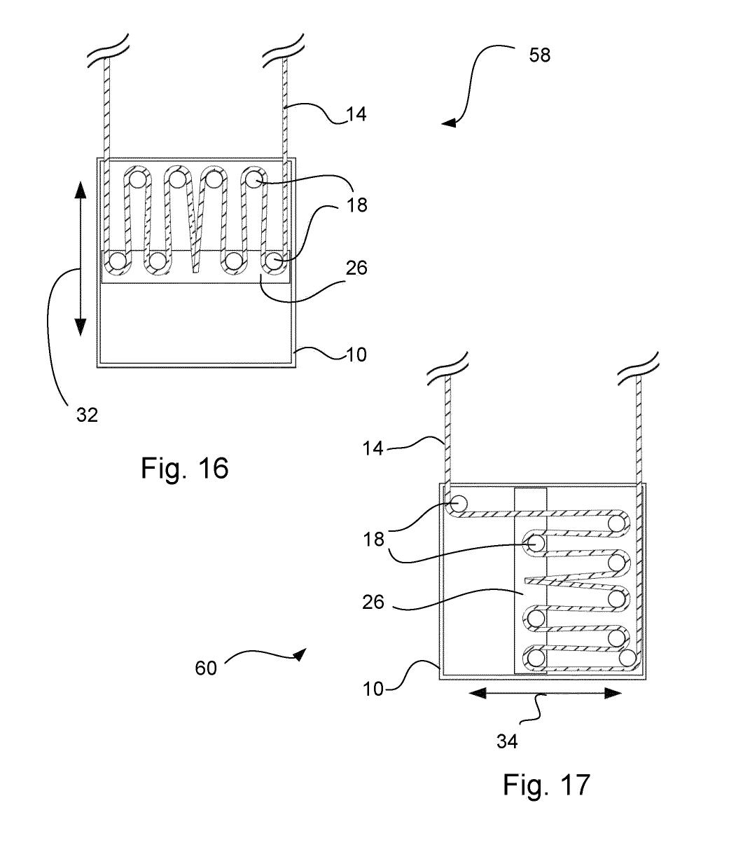

In FIG. 17, embodiment 60 features pivotal drums 18 on housing 10 on each side of slider 26. Slider 26 moves in a side-to-side direction 34 to extend and retract the lanyard 14. In contrast, embodiment 58 in FIG. 16 features slider 26 configured to move in an up-and-down direction 32.

Configurations like embodiment 60 which have pivotal drums 18 on either side of slider 26 may be advantageous for embodiments that do not have a ridge 36 upon which the device 6 or housing cover 34 would otherwise rest. In embodiment 60 the slightly longer pivotal drums 18 on the housing 10 can take the pressure from the device 6 or housing cover 34 and may therefore reduce the likelihood of any frictional constriction on pivotal drums 18 on slider 26 that would otherwise affect its freedom to move if a ridge 36 was not present.

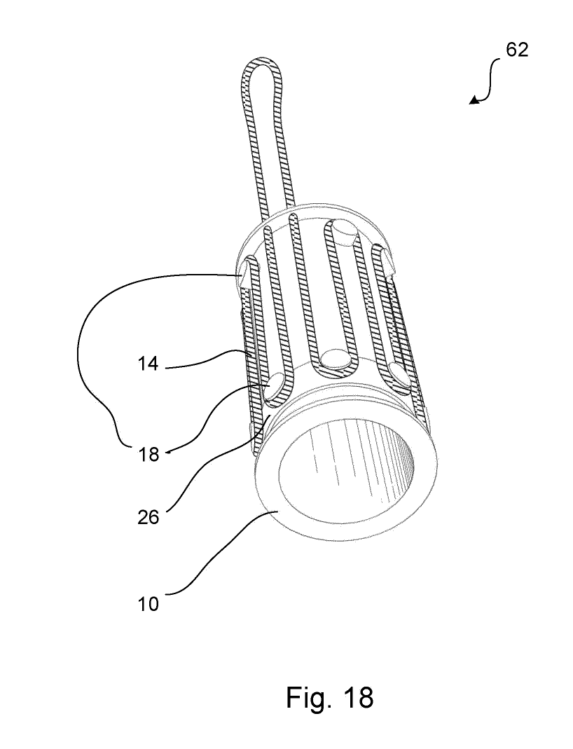

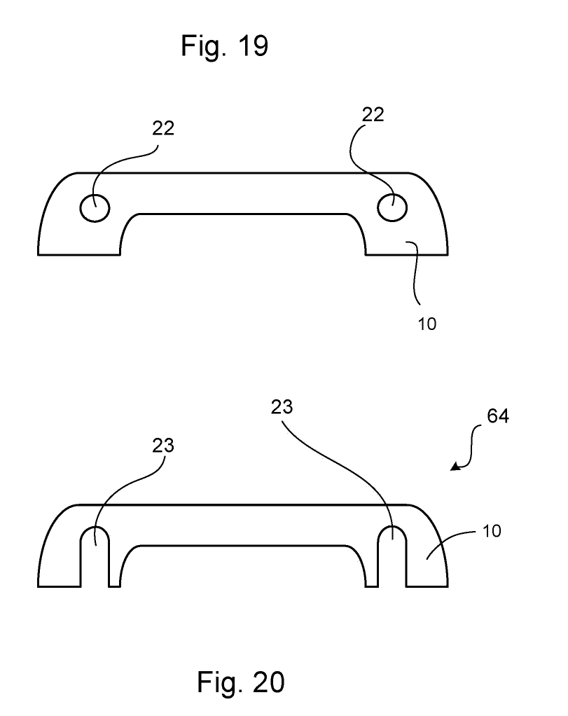

In FIG. 18 embodiment 62 is configured for use on a cylindrical mobile device 6, such as a flashlight or other cylinder. Although not shown, housing cover 34 would ensure that the inside movement of the lanyard 14 and the slider 26 is not inadvertently impeded by contact with a user when it is used with a device attached to the inside of the housing 10. Embodiment 62 could also be used inside a device 6 that has a shape of hollow cylinder, in which case housing cover 34 would be of lesser importance.

The operation of embodiment 62 involves movement of slider 26 up to lengthen the amount of lanyard 14 outside of the housing 10 and movement of slider 26 downward to shorten the amount of lanyard 14 outside of housing 10.

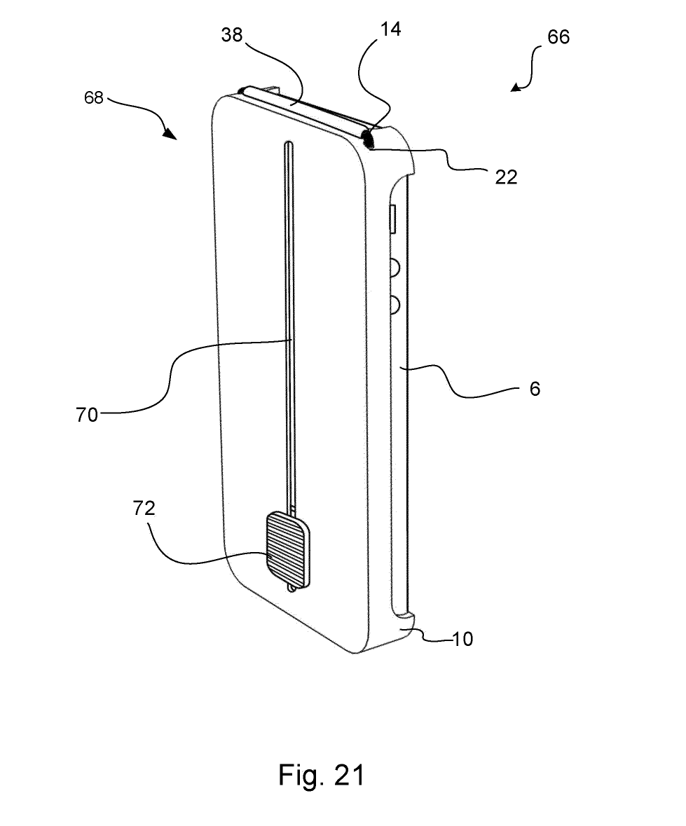

In FIG. 21, embodiment 66 features a holder system 68 having a slot or channel 70 in the rear of housing 10 through which a tab 72 can be accessed and moved up and down by a user. Tab 72 is attached to slider 26, permitting a means to move slider 26 downward to retract the lanyard 14 into housing 10 without requiring pulling on a wrist strap 16. In embodiment 66 a separate wrist strap 16 is not necessary. In alternative embodiments, the tab 72 can be attached to the slider 26 in a manner that permits lateral movement of the tab 72 within the slider 26. Channel 70 can be equipped with side branches that facilitate locking the slider 26 at one or more positions by sliding the tab 72 sideways from the main slot of channel 70. The locking positions could correspond to providing loops of certain lengths such as one or more locking positions for use of the lanyard 14 around a user's wrist or around other object, as well as positions for use of the lanyard around a user's neck, and a fully retracted position.

The invention has been described as having means attached to the slider 26 for pulling the slider 26 down, whether that be a wrist strap 16 or a tab 72. However it is to be understood that in a base embodiment it may be possible to practice the invention without a wrist strap 16 or tab 72, for example by separating the housing 10 from the device 6 and moving the slider 26 with the user's hand. While this would not be as fast and easy a manner to alter the length of the lanyard 14 as using a wrist strap 16 or tab 72 would be, it may be sufficient in certain circumstances where the length of lanyard 14 to be adjusted is only occasionally desired to be altered.

When considering the location of the housing cover 34, it is to be understood that the housing cover 34 could be placed on the back in which case the solid portion of housing 10 would be placed against the back of the device 6 when the device is held in position. In such embodiments, housing 10 would form a barrier between the slider 26 and the device 6. In embodiments with the housing cover 34 is on the back, manually adjusting the position of the slider 26 in embodiments without a wrist strap 16 or tab 72 would be easier than if the housing cover 34 were positioned between the slider 26 and the device 6.

The pivotal drums 18 may be of various diameters chosen to work well with the chosen lanyard 14. For example, where the lanyard 14 has a small diameter, the pivotal drums 18 could also have a small diameter, potentially as small as a pin. The diameter of the pivotal drum 18 can be chosen upon testing with a particular type of lanyard 14 to ensure ease of movement of the slider 26 within the housing 10 to retract and extend the lanyard 14 outside the housing 10. The pivotal drums 18 may be provided with diameters of 1 mm to 30 mm, or more preferably from a diameter between 3 mm and 10 mm.

The interaction between the slider tracks 20 and the threads 28 work to guide the slider 26 along the two intended directions on the inside of the housing 10. Many variations on this theme would be understood to provide the same function, whether there is only one or multiple sets of slider tracks 20 and corresponding threads 28, including whether the slider tracks 20 are on the housing 10 or on the slider 26, with the corresponding threads 28 on the other item. Further, slider tracks 20 and threads 28 may be unnecessary where the shape of the slider 26 and the fit within the housing 10 is such that movement in an unintended direction, or twisting of slider 26, would be unlikely to occur.

As will be apparent to those skilled in the art in the light of the foregoing disclosure the present invention is not limited by what has been particularly shown and described herein. Rather the scope of the present invention includes both combinations and sub-combinations of the features described hereinabove as well as modifications and variations thereof which would occur to a person of skill in the art upon reading the foregoing description and which are not in the prior art. Furthermore, many alterations and modifications are possible in the practice of this invention without departing from the spirit or scope thereof. Accordingly, the scope of the invention is to be construed in accordance with the substance defined by the following claims.

What is claimed is:

1. Apparatus for holding a device comprising:
a housing having a device receiving location;
a movable member having a pivot member thereon, said moveable member moveable proximate an inside surface of said housing;
a lanyard, said lanyard passing through a first opening in said housing such that an outside portion of said lanyard is outside said housing and an inside portion of said lanyard is inside said housing;
said inside portion of said lanyard threaded around said pivot member such that movement of said movable member in a retracting direction increases said inside portion of said lanyard while decreasing said outside portion of said lanyard and movement of said movable member in an extending direction decreases said inside portion of said lanyard while increasing said outside portion of said lanyard.

2. An apparatus as in claim 1, further comprising means for moving said movable member between said retracting direction and said extending direction.

3. An apparatus as in claim 2, further comprising said lanyard passing through a second opening in said housing such that said outside portion of said lanyard forms a loop.

4. An apparatus as in claim 3, wherein said means for moving said movable member comprises a wrist strap connected to said moveable member, said wrist strap passing through an aperture in said housing.

5. An apparatus as in claim 3, wherein said means for moving said movable member comprises a tab moveable along a channel in said housing.

6. An apparatus as in claim 4, wherein said first and second openings are holes.

7. An apparatus as in claim 4, wherein said first and second openings are slits.

8. An apparatus as in claim 6, further comprising a neck strap comfort section coupled to said outside portion of said lanyard.

9. An apparatus as in claim 8 said movable member comprising a plurality of pivot members thereon.

10. An apparatus as in claim 9 further comprising a pivot drum on said housing.

11. An apparatus as in claim 9 further comprising a plurality of pivot drums on said housing, said lanyard threaded around said pivot members and around said pivot drums wherein pulling on said wrist strap coupled to said movable member retracts said lanyard and extends said wrist strap and pulling on said lanyard retracts said wrist strap and extends said lanyard.

12. An apparatus as in claim 11, further comprising a housing cover coupled to said housing and positioned between said slider and said device receiving location.

13. An apparatus as in claim 12, further comprising a slider track and a thread combination for guiding movement of said moveable member along said housing.

14. Apparatus for holding a device comprising:
a housing having a device receiving location;
said housing having a plurality of pivot drums thereon;
a movable member having a plurality of pivot members thereon, said moveable member moveable proximate an inside surface of said housing;
a lanyard, said lanyard passing through first and second openings in said housing such that an outside portion of said lanyard forms a loop;
an inside portion of said lanyard being threaded around said pivot members and said pivot drums; and
a wrist strap coupled to said slider, said wrist strap passing through an aperture in said housing, wherein pulling said wrist strap downward retracts said lanyard and extends said wrist strap and pulling on said lanyard retracts said wrist strap and extends said lanyard.

15. An apparatus as in claim 14, further comprising a housing cover coupled to said housing and positioned between said moveable member and said device receiving location.

16. An apparatus as in claim 14, further comprising a slider track and a thread combination for guiding movement of said slider along said housing.

17. A method of retracting and extending a lanyard within a holder for a device comprising:
pulling upward on said lanyard to extend said lanyard outside said holder; and
moving downward a means for moving a moveable member to retract said lanyard into said holder.

18. The method of claim 17 wherein moving downward a means for moving a moveable member comprises pulling a wrist strap downward.

19. The method of claim 18 wherein pulling upward on said lanyard comprises retracting said wrist strap into said holder.

20. The method of claim 19 further comprising snapping said device into said holder.
